(19) United States
(12) Patent Application Publication
(10) Pub. No.: US 2021/0286391 A1
(43) Pub. Date: Sep. 16, 2021

(54) MULTI-VOLTAGE CONTROL ASSESSOR

(71) Applicant: Michael R. Voils, Beasley, TX (US)

(72) Inventor: Michael R. Voils, Beasley, TX (US)

(21) Appl. No.: 16/818,054

(22) Filed: Mar. 13, 2020

(51) Int. Cl. G05F 1/66; H02J 13/00; H02J 3/12

(52) U.S. Cl. CPC G05F 1/66; H02J 3/12; H02J 13/00007

(57) ABSTRACT

The multi-voltage control assessor for providing a set of standard voltages useful in testing electrical devices and systems is disclosed. The Multi-Voltage Control Assesor (MVCA) is a portable, small suitcase sized device containing transformers, switches, safety devices and cabling that, when operated safely by a competent person, can provide common voltages to power controls, relays and small devices intended for troubleshooting purposes. It can also temporarily substitute for a control transformer for a critical device, as necessary. It is not recommended for this to be a full time use, only until a suitable replacement can be installed.

### TECHNICAL FIELD

This application relates in general to an article of manufacture for providing a set of standard voltages useful in testing electrical devices and systems.

### BACKGROUND

Technicians need to provide common voltages to power controls, relays, and small devices intended for troubleshooting purposes. These voltages may not always be readily available to provide to circuits and devices under test. A portable source for these common voltages that is easily configurable to provide a particular voltage in the field for testing typically requires transportation and use of multiple devices. A need exist to provide a portable source that may provide any number of common voltage values for testing.

The present invention attempts to address the existing limitations in providing test voltages to electrical devices and systems according to the principles and example embodiments disclosed herein.

### SUMMARY

In accordance with the present invention, the above and other problems are solved by providing an article of manufacture for providing a set of standard voltages useful in testing electrical devices and systems.

In one embodiment, the present invention is an article of manufacture for providing a set of standard voltages useful in testing electrical devices and systems is disclosed.

The great utility of the invention is that the article of manufacture may provide a set of standard voltages useful in testing electrical devices and systems having controls on which voltage and how it is activated in an easily portable and self-contained device.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment an article of manufacture for providing a set of standard voltages useful in testing electrical devices and systems according to the present invention.

FIG. 2 illustrates a circuit schematic for an example embodiment for an article of manufacture for providing a set of standard voltages useful in testing electrical devices and systems according to the present invention.

FIG. 3 illustrates a circuit schematic for another example embodiment for an article of manufacture for providing a set of standard voltages useful in testing electrical devices and systems according to the present invention.

### DETAILED DESCRIPTION

This application relates in general an article of manufacture for providing a set of standard voltages useful in testing electrical devices and systems.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of 50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “circuit” refers to a collection of electrical components coupled together to create a device or system powered by electrical voltages. The circuit may be small and self-contained or a device that is part of a larger interconnected system. The circuit is typically under test control when using the present invention.

The term “user” and “technician” refers to an entity, e.g. a human, that operates a multi-voltage control assessor device according to the present invention in order to bring about a desired effect or outcome, particularly provide test input voltages to a circuit. For such a user, the terms “user” and “technician” may be used herein interchangeably.

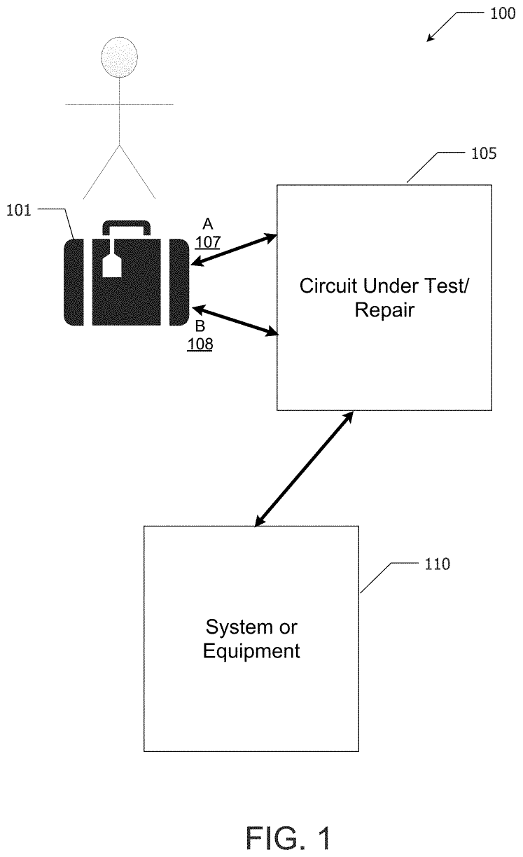

In general, the present disclosure relates general to an article of manufacture for providing a set of standard voltages useful in testing electrical devices and systems. To better understand the present invention, FIG. 1 illustrates one potential embodiment an article of manufacture for providing a set of standard voltages useful in testing electrical devices and systems according to the present invention.

The Multi-Voltage Control Assessor (MVCA) 101 is a portable, small suitcase sized device containing transformers, switches, safety devices and cabling that, when operated safely by a competent person, can provide common voltages to a circuit under test 102 that may be part of a larger system 103 such as power controls, relays and small devices intended for troubleshooting purposes.

The MVCA 101 may also temporarily substitute for a control transformer for a critical device, as necessary. The MVCA 101 is not recommended to be used in a full time arrangement, only until a suitable replacement can be installed.

The MVCA 101 allows a technician to isolate specific points in a control circuit 105 to determine if that device has failed or if the issue is in another location. This MVCA device 101 may be extremely useful in troubleshooting motor control circuits and relay-heavy Programmable Logic Circuits (PLC circuits). The PLC circuits are typically removed from the circuit to prevent damage.

The MVCA device 101 is contained within a plastic/PVC “Pelican” style case with a “Hand-Off-Auto” switch to be designated “momentary (or test)/off/constant”, a momentary push-button designated “Test” to provide power only while pressed, and a circuit breaker rated 120 V/2A and a 6-position “Voltage” switch designated 12 VDC, 24 VDC, 24 VAC, 120 VAC, 240 VAC, and 480 VAC. This switch will be rated to handle the 120 VAC power. There are two electrical lead receptacles on the device, fitted to receive any standard metering leads. These are red and black in color, designated “A” 107 and “B” 108 respectively.

In order to properly troubleshoot each of the individual pieces of a control system 105, portions had to be rewired and bypassed to determine if without the given instrument whether or not the system 110 would work, as well as a more than passing knowledge of the given control system 105 and specifically how it is designed to operate. With the MVCA device 101, the technician only need to disconnect a couple of wires, connect leads from the MVCA 101, switch a control input to the correct voltage, and push a button. Also the MVCA 101 may be used as a temporary power source, if necessary, for a given control system 105.

The MVCA device 101 may also be used to operate the entire control circuit without applying voltage to the device that is intended to be controlled. i.e. the MVCA device 101can be configured to have all power off of a motor and control the starter for testing without actually turning the motor on or off. This arrangement provides an increased safety factor and prevents damage to the motor as well.

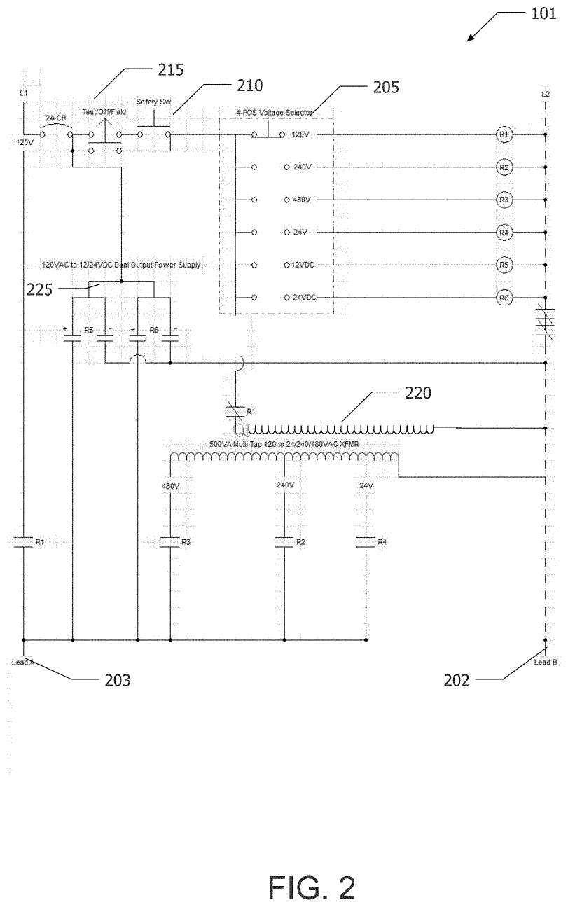

FIG. 2 illustrates a circuit schematic for an example embodiment for an article of manufacture for providing a set of standard voltages useful in testing electrical devices and systems according to the present invention.

One embodiment of the MVCA 101 includes six relays 207a-f with both normally open and normally closed contacts, a 12/24 VDC dual output power supply 225, and a multitap transformer 220 with taps to support 24 VAC, 240 VAC and 480 VAC. Optionally transformer 220 may be exchanged for multiple transformers, if necessary. Power is supplied to the unit via a standard Nema 5-15 male power cord, removable from the MVCA device 101 using a computer power cable and outlet.

Power routes through the circuit breaker first, then is paralleled between the constant and momentary positions. The momentary position passes through the momentary push button 215, while the constant position applies constant power through the device.

The Voltage switch 205 routes the 120V power to a series of relays 207a-f which operate to allow the correct voltage to reach the test leads A 202 and B 203. The relays 207a-f also serve to prevent back-feeds to the transformer 220 or the source power 225. Constant power is fed to a dual output DC power supply 225, where the relays are coordinated to prevent AC/DC crossover or back-feeds.

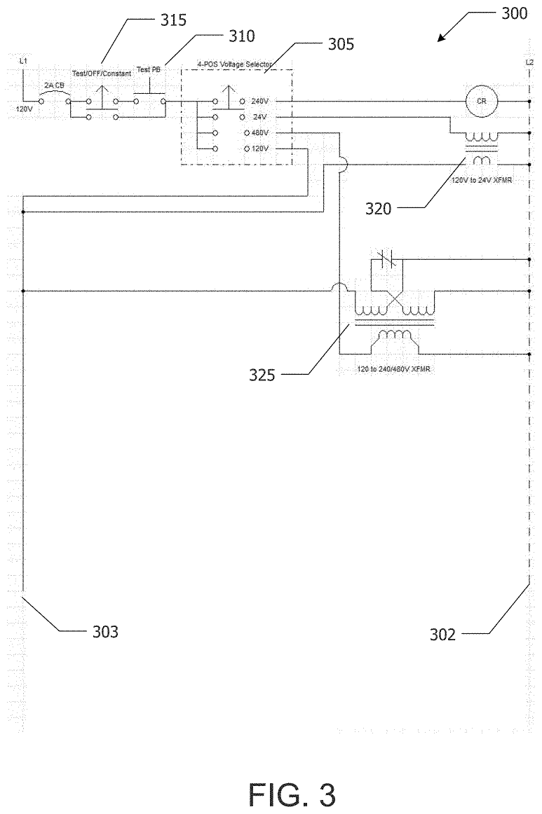

FIG. 3 illustrates a circuit schematic for another example embodiment for an article of manufacture for providing a set of standard voltages useful in testing electrical devices and systems according to the present invention.

Another embodiment of an MVCA device 300 is currently in a PVC enclosure with an ON/OFF switch 315, a “Hand-Off-Auto” switch to be designated “momentary/off/constant”, a momentary push-button 310 designated “Test” to provide power only while pressed, and a circuit breaker rated 120 V/2 A and a 4-position “Voltage” switch 305 designated 24 VAC, 120 VAC, 240 VAC, and 480 VAC. This switch 305 will be rated to handle the 120 VAC power. There is a Nema 5-15 female cord to receive the test leads, which are alligator clips attached to a Nema 5-15 Plug.

Power is supplied to the unit via a standard Nema 5-15 male power cord. Power routes through the circuit breaker first, then is paralleled between the constant and momentary positions. The momentary position passes through the momentary push button, while the constant position applies constant power through the device.

The Voltage switch routes the 120V power to a series of relays which operate to allow the correct voltage to reach the test leads A 302 and B 303 The relays also serve to prevent back-feeds to the transformer or the source.

While the above embodiments are described to generate a specific set of output voltages, both DCV and ACV, these example voltages are not intended to limit the invention as defined in the attached claims. For any definition of the present invention, the claim language and not any specific example embodiment should control.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A multi-voltage control assessor for providing a set of standard voltages useful in testing electrical devices and systems, the multi-voltage control assessor comprises:
a pair of output terminals, the pair of output terminals having a positive terminal and a negative terminal;
a Hand-Off-Auto switch to provide a selected output voltage automatically;
a momentary push-button to provide the selected output voltage only while pressed;
a multi-position selector switch, the multi-position selector switch having a plurality of output voltages coupled to one of a plurality of input terminals and an output terminal connected one of the plurality of output voltages as selected by the multi-position selector switch; and
the plurality of voltage sources internally generated from a single external input voltage;
wherein the plurality of output voltages are connected to the output terminals through a corresponding relay isolating each of the plurality of output voltages from each other.

2. The multi-voltage control assessor according to claim 1, wherein the plurality of output voltages are generated from two or more taps on a multi-tap transformer.

3. The multi-voltage control assessor according to claim 2, wherein the plurality of output voltages comprises 24 VAC, 120 VAC, 240 VAC, and 480 VAC.

4. The multi-voltage control assessor according to claim 2, wherein the plurality of output voltages are further generated from a multi-voltage DC power supply.

5. The multi-voltage control assessor according to claim 4, wherein the multi-voltage DC power supply comprises a 12/24 VDC power supply.

6. The multi-voltage control assessor according to claim 1, wherein the multi-voltage control assessor is contained within a portable, small suitcase sized container.
